(19) United States
(12) Patent Application Publication
(10) Pub. No.: US 2016/0069394 A1
(43) Pub. Date: Mar. 10, 2016

(54) Method For Controlling Bearing Clearance Of Wheel Bearing Apparatus

(71) Applicant: NTN Corporation, Osaka-shi (JP)

(72) Inventor: Yuuki OGATA, Iwata-shi (JP)

(21) Appl. No.: 14/880,245

(22) Filed: Oct. 11, 2015

Related U.S. Application Data
(63) Continuation of application No. PCT/JP2014/060441, filed on Apr. 10, 2014.

(30) Foreign Application Priority Data
Apr. 11, 2013 (JP) 2013-082777

(51) Int. Cl. F16C 43/04; B60B 27/00

(52) U.S. Cl. CPC F16C 43/04; B60B 27/0005; B60B 27/0078

(57) ABSTRACT

A method for controlling bearing clearance of a wheel bearing apparatus that has an axial distance T0 and an initial axial clearance δ0 measured between reference surfaces of the wheel hub and the inner ring. A press-fitting operation is temporally stopped while under a positive bearing clearance state during press-fitting of the inner ring onto the cylindrical portion of the wheel hub. An axial distance T1 is measured between the reference surfaces after continuing and completing the press-fitting operation. An axial clearance is obtained δ1 under this state from a formula δ1=δ0−(T0−T1). An axial distance T2 is obtained, after the caulking operation, between the reference surfaces from a formula T2=δ2−δ1−T1. Thus, the axial distance T2 becomes a target value of the bearing clearance δ2, after the caulking operation. A completion end position of the caulking operation of a caulking apparatus is changed.

### CROSS-REFERENCE TO RELATED APPLICATIONS

This application is a continuation of International Application No. PCT/JP2014/060441, filed Apr. 10, 2014, which claims priority to Japanese Application No. 2013-082777, filed Apr. 11, 2013. The disclosures of the above applications are incorporating herein by reference.

### FIELD

The present disclosure relates to a method for controlling bearing clearance of a wheel bearing apparatus that rotationally supports a vehicle wheel, such as an automobile and, more particularly, to a method for controlling bearing clearance of a wheel bearing apparatus where the bearing clearance is set to a predetermined negative clearance by applying a preload.

### BACKGROUND

Heretofore, a predetermined bearing preload has been applied to wheel bearing apparatus to ensure a desirable bearing rigidity. A representative example of this kind of the wheel bearing apparatus is shown in FIG. 13. In descriptions of this specification, the term “outboard-side” means a side positioned outside of a vehicle body (e.g. left-side of FIG. 13). The term “inboard-side” means a side positioned inside of a vehicle body (e.g. right-side of FIG. 13) when the wheel bearing apparatus is mounted on a vehicle.

The wheel bearing apparatus is a third generation type used for a driving wheel. It comprises an inner member 51, an outer member 52, and double row balls 53, 53 rollably contained between the inner and outer members 51, 52. The inner member 51 includes a wheel hub 54 and an inner ring 55 press-fit onto the wheel hub 54.

The wheel hub 54 is integrally formed with a wheel mounting flange 56 at its outboard-side end. Hub bolts 56a, to secure a wheel, are arranged on the wheel mounting flange 56 equidistantly along its periphery. In addition, the wheel hub 54 is formed on its outer circumference with an inner raceway surface 54a. The wheel hub 54 inner circumference includes serrations (or splines) 54c for torque transmission purposes. A cylindrical portion 54b axially extends from the inner raceway surface 54a.

The inner ring 55 is formed, on its outer circumference, with an inner raceway surface 55a. The inner ring 55 is press-fit onto the cylindrical portion 54b of the wheel hub 54. The inner ring 55 is secured by a caulked portion 54d. The caulked portion 54d is formed by plastically deforming the end of the cylindrical portion 54b radially outward. This prevents the inner ring 55 from axially slipping off of the wheel hub 54.

The outer member 52 is integrally formed with a body mounting flange 52b, on its outer circumference, to be mounted on a vehicle body (not shown). The outer member 52 inner circumference includes double row outer raceway surfaces 52a, 52a. The double row balls 53, 53 are contained between the inner raceway surfaces 54a, 55a and the outer raceway surfaces 52a, 52a. The balls 53, 53 are freely rollably held by cages 57, 57. In addition, seals 58, 59 are mounted on both ends of the outer member 52. The seals 58, 59 prevent leakage of lubricating grease contained within the bearing and entry of rain water or dust into the bearing from the outside.

This wheel bearing apparatus adopts a so-called self-retaining structure where the inner ring 55 is secured by the caulked portion 54d. The caulked portion 54d is formed by plastically deforming the end of the cylindrical portion 54b of the wheel hub 54 radially outward. Thus, it is unnecessary, as in previous wheel bearing apparatus, to control the preload amount by strongly fastening a nut, etc. Accordingly, it is possible to simplify assembly of the wheel bearing apparatus to a vehicle and to maintain the preload amount for a long term. However, the bearing clearance is varied by deformation of the inner ring 55 due to the caulking operation or variations of the caulking load. Thus, it is difficult to exactly control the preload amount among the wheel bearing apparatus.

Accordingly, the following assembling process of the wheel bearing apparatus has been performed. First, the inner ring 55 is press-fit onto the cylindrical portion 54b of the wheel hub 54, as shown in FIG. 14. The press-fitting operation is stopped once just before a smaller end face 60 of the inner ring 55 abuts against a shoulder portion 61 of the wheel hub 54. A predetermined distance S remains at this time between the smaller end face 60 of the inner ring 55 and the shoulder portion 61 of the wheel hub 54. Thus, the axial clearance of the bearing is positive. Under this state, an axial distance t0 from a reference surface (larger end face) 62 of the inner ring 55 to a reference surface (flange side surface) 63 of the wheel hub 54 is measured. An initial axial clearance δ0 of the bearing is measured from an axial moving amount of the outer member 52 relative to the inner member 51.

Next, the inner ring 55 is continuously press-fit onto the wheel hub 54 until the smaller end face 60 of the inner ring 55 abuts against the shoulder portion 61 of the wheel hub 54, as shown in FIG. 15. An axial distance t1 from the reference surface 62 of the inner ring 55 to the reference surface 63 of the wheel hub 54 is measured. An axial bearing clearance δ1 after the press-fitting of the inner ring 55 onto the wheel hub 54 is obtained from a formula δ1=δ0−(t0−t1).

The caulking operation is performed. An axial distance t2 from the reference surface 62 of the inner ring 55 to the reference surface 63 of the wheel hub 54, after the caulking, is measured, as shown in FIG. 13. Although the preload amount is increased because of the reduction of the bearing clearance due to caulking, the clearance reduction amount (preload increment) can be expressed as (t1−t2). Accordingly, the bearing clearance (preload amount) 62 of a finally assembled wheel bearing apparatus after caulking can be obtained from a formula δ2=δ1+(t1−t2).

According to such bearing clearance control method of the prior art, it is possible to provide a wheel bearing apparatus where the appropriate preload amount can be guaranteed by controlling the negative bearing clearance after assembly of the wheel bearing apparatus based on measured values in the assembling process of the wheel bearing apparatus (see, e.g. JP 2001-225606 A)

However, in the prior art bearing clearance control method, although it is possible to obtain the preload amount of the bearing from the bearing clearance (preload amount) δ2 of the finally assembled bearing apparatus, of which caulking having been completed, it is very difficult in the real assembling process to accurately and stably control the final bearing clearance δ2. This is due to the variation of the bearing clearance δ1 before caulking or variation of the decrement (t1−t2) of the bearing clearance, due to the caulking operation.

### SUMMARY

It is therefore an object of the present disclosure to provide a method for controlling bearing clearance of the wheel bearing apparatus that can exactly and stably control the bearing clearance. Operation processing measured values of the bearing clearance and assembly width are inputted into a computer before caulking of a previously measured individual wheel bearing apparatus. A completion end position of the caulking operation of a caulking apparatus is corrected so that the bearing clearance after caulking becomes constant.

A method for controlling bearing clearance of a wheel bearing apparatus is achieved by providing an outer member, inner member and double row rolling element. The outer member outer circumference includes a body mounting flange to be mounted on a body of a vehicle. The outer member inner circumference includes double row outer raceway surfaces. The inner member includes a wheel hub and an inner ring or an outer joint member of a constant velocity universal joint. The wheel hub, on its one end, includes a wheel mounting flange. A cylindrical portion axially extends from the wheel mounting flange. The inner ring or the outer joint member is press-fit onto or into the cylindrical portion of the wheel hub. The inner member outer circumference includes double row inner raceway surfaces. The double row inner raceway surfaces oppose the double row outer raceway surfaces. The double row rolling elements are freely rollably contained between the outer raceway surfaces of the outer member and the inner raceway surfaces of the inner member. The inner ring or the outer joint member is secured on the wheel hub by a caulked portion. The caulked portion is formed by plastically deforming the end of the cylindrical portion of the wheel hub or the end of the outer joint member radially outward. The method comprises steps of measuring an axial distance T0 and an initial axial clearance δ0 between reference surfaces of the wheel hub and the inner ring or reference surfaces of the wheel hub and the outer joint member. Temporally stopping the press-fitting operation under a positive bearing clearance state during press-fitting of the inner ring or the outer joint member onto or into the cylindrical portion of the wheel hub. Measuring an axial distance T1 between the reference surfaces of the wheel hub and the inner ring or the reference surfaces of the wheel hub and the outer joint member after further continuation and completion of the press-fitting operation. Obtaining an axial clearance δ1 under this state from a formula δ1=δ0−(T0−T1). Obtaining an axial distance T2 after the caulking operation between the reference surfaces of the wheel hub and the inner ring or the reference surfaces of the wheel hub and the outer joint member from a formula T2=δ2−δ1−T1. Thus, the axial distance T2 becomes a target value of the bearing clearance δ2 after the caulking operation. Changing a completion end position of the caulking operation of a caulking apparatus.

The inner ring or the outer joint member is secured on the wheel hub by a caulked portion. The caulked portion is formed by plastically deforming the end of the cylindrical portion of the wheel hub or the end of the outer joint member radially outward. Further, the method comprises the steps of measuring an axial distance T0 and an initial axial clearance δ0 between reference surfaces of the wheel hub and the inner ring or reference surfaces of the wheel hub and the outer joint member. Temporally stopping the press-fitting operation under a positive bearing clearance state during press-fitting of the inner ring or the outer joint member onto or into the cylindrical portion of the wheel hub. Measuring an axial distance T1 between the reference surfaces of the wheel hub and the inner ring or the reference surfaces of the wheel hub and the outer joint member after further continuation and completion of the press-fitting operation. Obtaining an axial clearance δ1 under this state from a formula δ1=δ0−(T0−T1). Obtain an axial distance T2 after the caulking operation between the reference surfaces of the wheel hub and the inner ring or the reference surfaces of the wheel hub and the outer joint member from a formula T2=δ2−δ1−T1. Thus, the axial distance T2 becomes a target value of the bearing clearance δ2 after the caulking operation. Change a completion end position of the caulking operation of a caulking apparatus. Thus, it is possible to exactly set a desirable bearing clearance and to also exactly and stably control the preload amount of bearing. This occurs even if variations exists in the materials or dimensions of the wheel hub or the outer joint member. In addition, it is possible to prevent the occurrence of defective product inconvenience in performances such as under-caulking or over-caulking and reduce manufacturing cost.

The method for controlling bearing clearance of a wheel bearing apparatus further comprises a step of arbitrarily changing the completion end position of the caulking operation of a caulking apparatus by a movable stopper.

The method for controlling bearing clearance of the wheel bearing apparatus further comprises steps of previously measuring a deformation amount of the inner ring due to the caulking operation. Adding a corrected value of the deformation amount converted to the axial direction to the bearing clearance δ2 after the caulking operation. This makes it possible to achieve a further exact control of the bearing clearance.

The method for controlling bearing clearance of the wheel bearing apparatus further comprises steps of transferring and storing the bearing clearance δ1 and the axial distance T1 information together with identification codes printed on individual wheel bearing apparatus before the caulking operation of the caulking apparatus. Retrieve the information just before the caulking operation by matching the identification codes to the information. This makes it possible to exactly, stably and effectively control the preload amount of the bearing if the process for press-fitting the inner ring onto or the outer joint member into the wheel hub and the caulking process are for each other.

The inner member includes the wheel hub and the outer joint member. The outer joint member is integrally formed with a cup-shaped mouth portion. A shoulder portion forms a bottom of the mouth portion. A cylindrical shaft portion axially extends from the shoulder portion. The shaft portion is formed with a spigot portion fit into the cylindrical portion of the wheel hub, via a predetermined interference. A serration is at one end of the spigot portion. A serration engaging the serration of the outer joint member is formed on the inner circumference of the wheel hub. A preload is applied to the wheel bearing apparatus by pressing the wheel hub with the outer joint member vertically placed on a receptacle table. The end of the shaft portion of the outer joint member is plastically deformed radially outward.

A wheel bearing apparatus of the present disclosure comprises an outer member, inner member and double row rolling element. The outer member outer circumference has a body mounting flange to be mounted on a body of a vehicle. The outer member inner circumference includes double row outer raceway surfaces. The inner member includes a wheel hub and an inner ring or an outer joint member of a constant velocity universal joint. The wheel hub, on its one end, includes a wheel mounting flange. A cylindrical portion axially extends from the wheel mounting flange. The inner ring or the outer joint member is press-fit onto or into the cylindrical portion of the wheel hub. The inner member outer circumference includes double row inner raceway surfaces that oppose the double row outer raceway surfaces. The double row rolling elements are freely rollably contained between the outer raceway surfaces of the outer member and the inner raceway surfaces of the inner member. The inner ring or the outer joint member is secured on the wheel hub by a caulked portion. The caulked portion is formed by plastically deforming the end of the cylindrical portion of the wheel hub or the end of the outer joint member, radially outward. The method for controlling the bearing clearance comprises steps of measuring an axial distance T0 and an initial axial clearance δ0 between reference surfaces of the wheel hub and the inner ring or reference surfaces of the wheel hub and the outer joint member. Temporally stopping the press-fitting operation under a positive bearing clearance state during press-fitting of the inner ring or the outer joint member onto or into the cylindrical portion of the wheel hub. Measuring an axial distance T1 between the reference surfaces of the wheel hub and the inner ring or the reference surfaces of the wheel hub and the outer joint member after further continuation and completion of the press-fitting operation. Obtain an axial clearance δ1 under this state from a formula δ1=δ0−(T0−T1). Obtain an axial distance T2 after the caulking operation between the reference surfaces of the wheel hub and the inner ring or the reference surfaces of the wheel hub and the outer joint member from a formula T2=δ2−δ1−T1. Thus, the axial distance T2 becomes a target value of the bearing clearance δ2 after the caulking operation. Change a completion end position of the caulking operation of a caulking apparatus. Thus, it is possible to exactly set desirable bearing clearance and also to exactly and stably control the preload amount of the bearing. This occurs even if there are variations in materials or dimensions of the wheel hub or the outer joint member. In addition, it is possible to prevent the occurrence of defective product inconvenience in performances such as under-caulking or over-caulking.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a longitudinal section view of a first preferable embodiment of the wheel bearing apparatus.

FIG. 2 is a partially enlarged view of an outboard-side seal of FIG. 1.

FIG. 3 is a partially enlarged view of an inboard-side seal of FIG. 1.

FIG. 4 is an explanatory view of a press-fitting process of an inner ring of FIG. 1.

FIG. 5 is an explanatory cross-section view of a state after the press-fitting process of the inner ring of FIG. 1.

FIG. 6 is an explanatory elevation view of a caulking apparatus.

FIG. 7 is an explanatory elevation view partially in cross section of a caulking process by the caulking apparatus of FIG. 6.

FIG. 8 is a process chart illustrating a method for controlling bearing clearance of wheel bearing apparatus.

FIG. 9 is a longitudinal section view showing a second preferable embodiment of the wheel bearing apparatus.

FIG. 10 is an explanatory cross section view of a press-fitting process of an outer joint member of FIG. 9.

FIG. 11 is an explanatory cross section view of a state after the press-fitting process of the outer joint member of FIG. 9.

FIG. 12 is an explanatory elevation view partially in section of a caulking process by the caulking apparatus of FIG. 6.

FIG. 13 is a longitudinal section view of a prior art finally assembled wheel bearing apparatus.

FIG. 14 is an explanatory cross-section view of an inner ring press-fitting process of the wheel bearing apparatus of FIG. 13.

FIG. 15 is an explanatory cross-section view of a state after the press-fitting process of the inner ring of the wheel bearing apparatus of FIG. 13.

### DETAILED DESCRIPTION

A method for controlling a bearing clearance of a wheel bearing apparatus where the wheel bearing apparatus comprises an outer member, an inner member and double row rolling elements. The outer member outer circumference includes a body mounting flange to be mounted on a body of a vehicle. The outer member inner circumference includes double row outer raceway surfaces. The inner member includes a wheel hub and an inner ring. The wheel hub, formed on its one end, includes a wheel mounting flange. A cylindrical portion axially extends from the wheel mounting flange. The inner ring is press-fit onto the cylindrical portion of the wheel hub. The inner ring outer circumference includes an inner raceway surface that opposes one of the double row outer raceway surfaces. The double row rolling elements are freely rollably contained between the outer raceway surfaces of the outer member and the inner raceway surfaces of the inner member. The inner ring is secured on the wheel hub by a caulked portion. The caulked portion is formed by plastically deforming the end of the cylindrical portion of the wheel hub radially outward. The method comprises steps of measuring an axial distance T0 and an initial axial clearance δ0 between reference surfaces of the wheel hub and the inner ring. Temporally stopping the press-fitting operation under a positive bearing clearance state during press-fitting of the inner ring onto the cylindrical portion of the wheel hub. Measuring an axial distance T1 between the reference surfaces of the wheel hub and the inner ring after further continuation and completion of the press-fitting operation. Obtaining an axial clearance δ1 under this state from a formula δ1=δ0−(T0−T1). Transfer, store and feedback the bearing clearance δ1 and the axial distance T1 together with identification codes printed on individual wheel bearing apparatus before the caulking operation to the caulking apparatus. Retrieving the information just before the caulking operation by matching the identification codes to the information. Obtain an axial distance T2 after the caulking operation between the reference surfaces of the wheel hub and the inner ring from a formula T2=δ2−δ1−T1. Thus, the axial distance T2 becomes a target value of the bearing clearance δ2 after the caulking operation. Change the completion end position of the caulking operation of a caulking apparatus.

Preferable embodiments of the present disclosure will be hereinafter described with reference to the drawings.

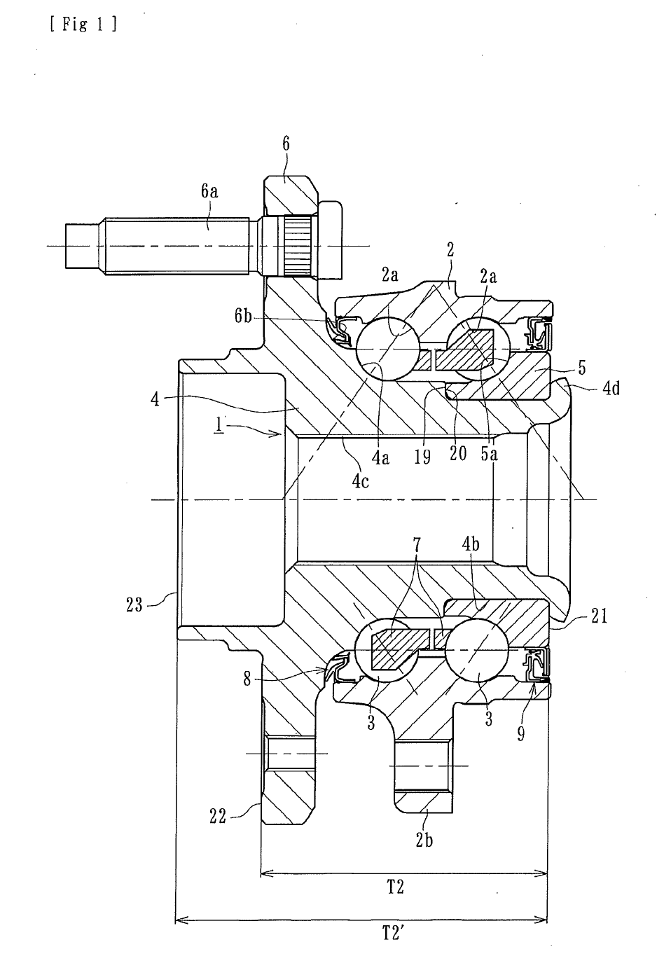

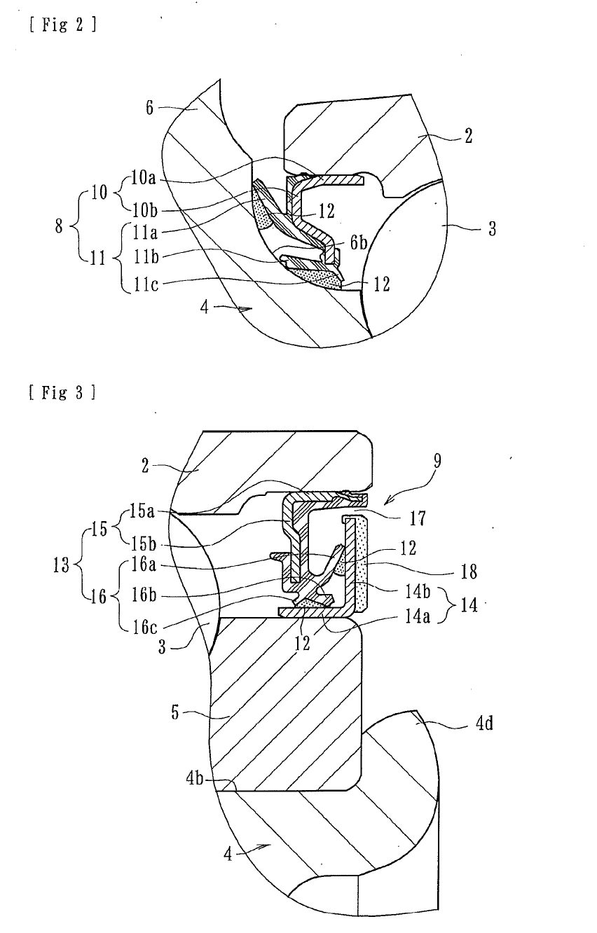

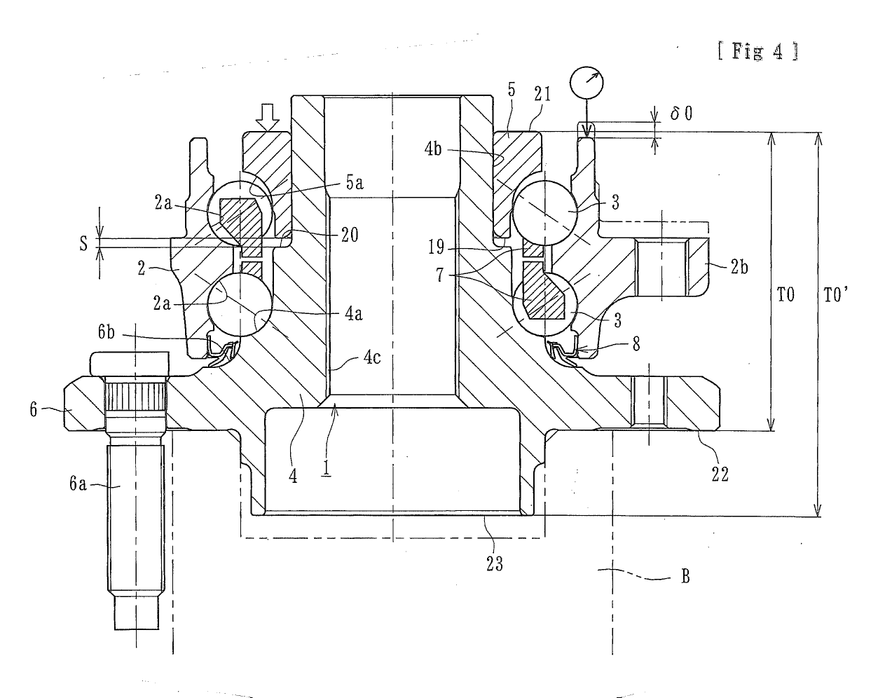

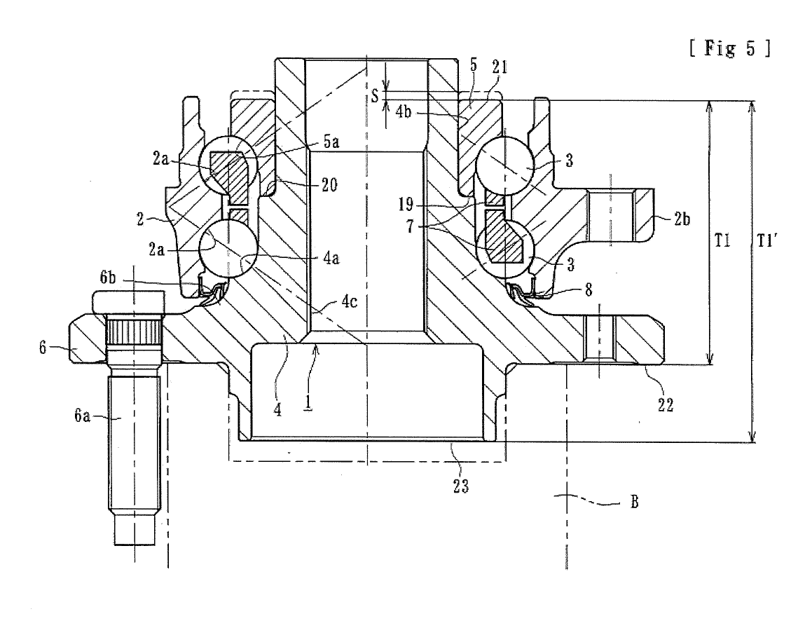

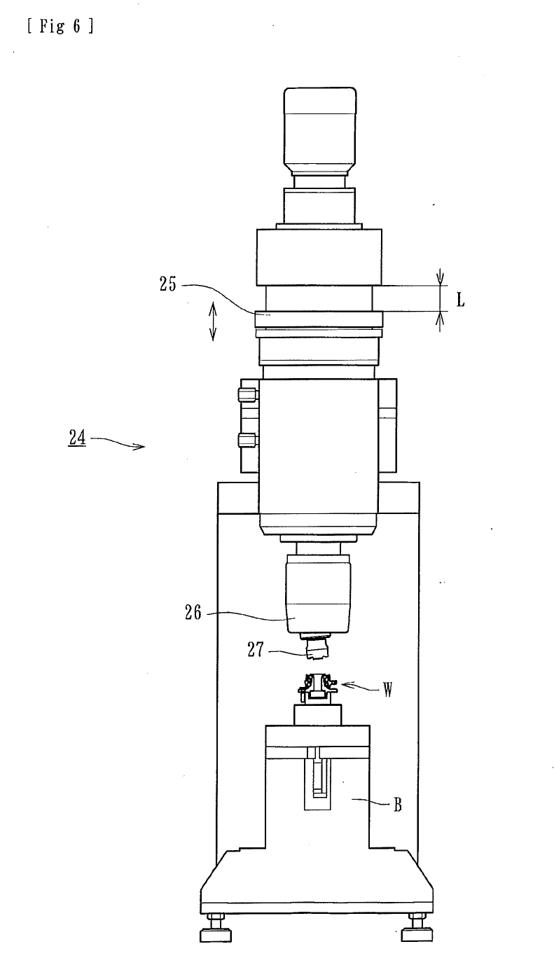

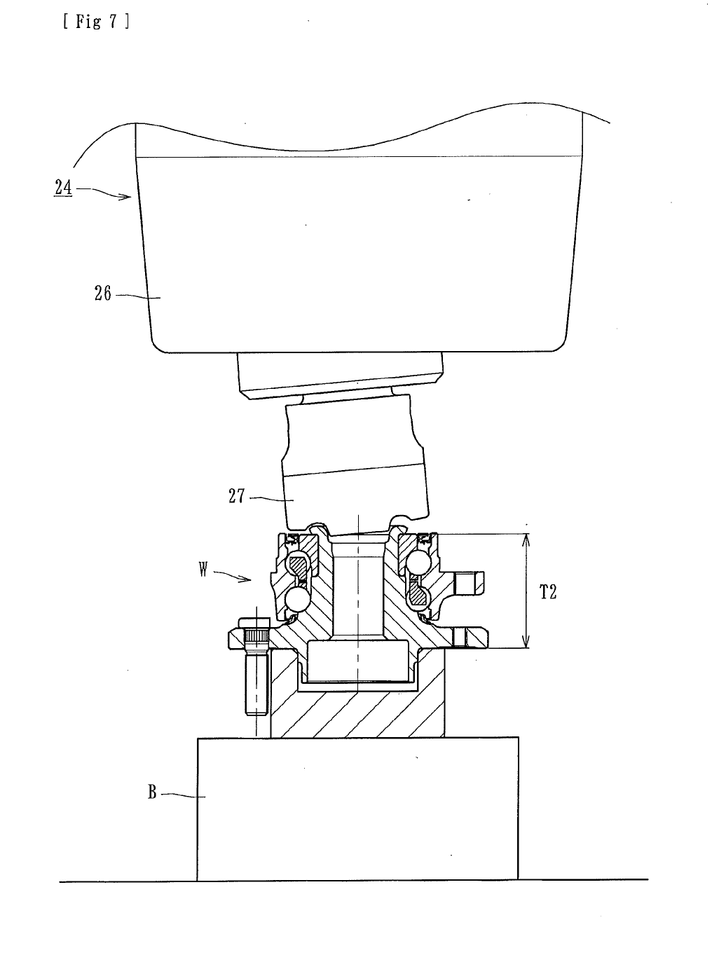

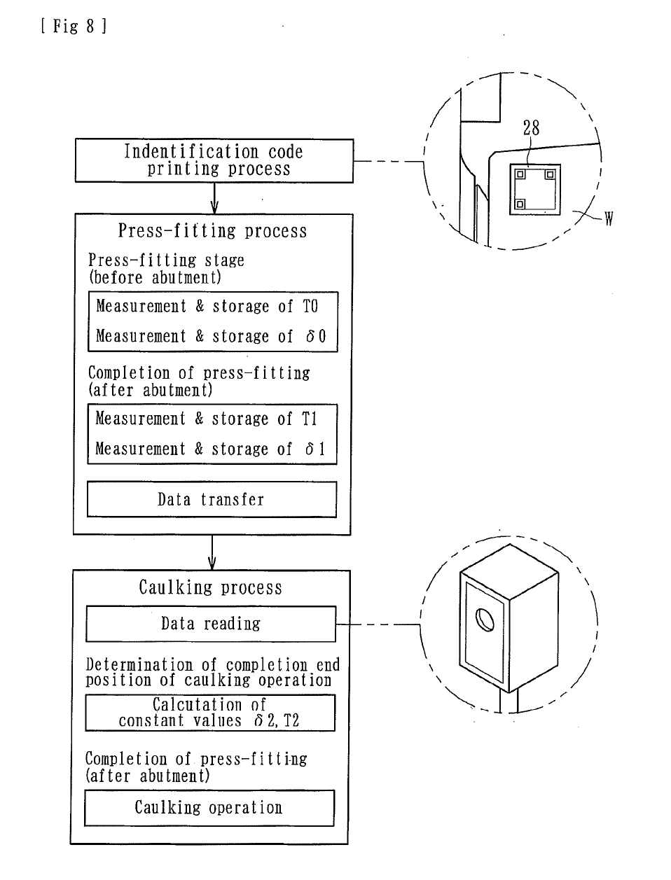

FIG. 1 is a longitudinal section view of a first preferable embodiment of the wheel bearing apparatus. FIG. 2 is a partially enlarged view of an outboard-side seal of FIG. 1. FIG. 3 is a partially enlarged view of an inboard-side seal of FIG. 1. FIG. 4 is an explanatory cross sectional view of a press-fitting process of an inner ring of FIG. 1. FIG. 5 is an explanatory sectional view of a state after the press-fitting process of the inner ring of FIG. 1. FIG. 6 is an explanatory view partially in cross section of a caulking apparatus. FIG. 7 is an explanatory view partially in section of a caulking process by the caulking apparatus of FIG. 6. FIG. 8 is a process chart of the method for controlling bearing clearance of wheel bearing apparatus.

The wheel bearing apparatus shown in FIG. 1 is a third generation type used for a driving wheel. It includes an inner member 1, an outer member 2, and double row rolling elements (balls) 3, 3 rollably contained between the inner and outer members 1, 2. The inner member 1 includes a wheel hub 4 and a separate inner ring 5 press-fit on the wheel hub 4.

The wheel hub 4 is integrally formed with a wheel mounting flange 6 at its outboard-side. Hub bolts 6a, to secure a wheel, are arranged equidistantly along the periphery of the wheel mounting flange 6. The wheel hub 4 outer circumference includes an inner raceway surface 4a. The wheel hub inner circumference includes serrations (or splines) 4c for torque transmission purposes. A cylindrical portion 4b axially extends from the inner raceway surface 4a.

The wheel hub 4 is made of medium/high carbon steel including carbon of 0.40 to 0.80% by weight such as S53C. It is hardened by high frequency induction quenching so that a region is hardened from a base 6b of the wheel mounting flange 6, forming a seal land portion of the seal 8, to the cylindrical portion 4b, including the inner raceway surface 4a, with a surface hardness of HRC 58 to 64. The end portion of the cylindrical portion 4b is not quenched. It remains as is with its surface hardness after forging less than HRC 25.

The inner ring 5 outer circumference includes an inner raceway surface 5a. The inner ring 5 is press-fit onto the cylindrical portion 4b of the wheel hub 4. The inner ring 5 is axially secured on the wheel hub 4 by a caulked portion 4d. The caulked portion 4d is formed by plastically deforming the end of the cylindrical portion 4b radially outward. The inner ring 5 and the rolling elements 3 are formed from high carbon chrome steel such as SUJ2. They are hardened to their core by dip quenching to have a hardness of HRC 58 to 64.

The outer member 2 is integrally formed, on its outer circumference, with a body mounting flange 2b to be mounted on a body (not shown) of a vehicle. The outer member inner circumference includes double row outer raceway surfaces 2a, 2a. Similarly to the wheel hub 4, the outer member 2 is formed of medium/high carbon steel including carbon of 0.40 to 0.80% by weight. At least the surfaces of the double row outer raceway surfaces 2a, 2a are hardened by high frequency induction quenching to have a surface hardness of HRC 58 to 64. The double row balls 3, 3 are contained between the outer raceway surfaces 2a, 2a and inner raceway surfaces 4a, 5a of the inner 1 and outer 2 members. The balls 3, 3 are rollably held by cages 7, 7. Seals 8, 9 are mounted within annular openings formed between the outer member 2 and the inner member 1. The seals 8, 9 prevent leakage of grease contained within the bearing and entry of rainwater or dust into the bearing from the outside.

According to the present embodiment, the outboard-side seal 8 is formed as an integrated seal. It includes a metal core 10 and a sealing member 11. The sealing member 11 integrally adhered to the metal core 10 via vulcanized adhesion, as shown in an enlarged view of FIG. 2. The metal core 10 is press-formed from ferritic stainless steel sheet (JIS SUS430 etc.), austenitic stainless steel sheet (JIS SUS304 etc.) or preserved cold rolled steel sheet (JIS SPCC etc.). The metal core 10 has a substantially L-shaped cross-section with a fitting portion 10a and a radial portion 10b. The cylindrical fitting portion 10a is fit into the outboard-side end of the outer member 2. The radial portion 10b extends radially inward from the end of the fitting portion 10a. The sealing member 11 extends to cover outer surfaces of the radial portion 10b, part of the fitting portion 10a and a part of an inner surface of the radial portion 10b. Thus, this forms a so-called “half metal structure”. This improves the sealability of the fitting portion 10a to protect the inside of the bearing.

The sealing member 11 is formed from synthetic rubber, such as NBR (acrylonitrile-butadiene rubber). The sealing member 11 includes a side lip 11a, a dust lip 11b and grease lip 11c. The side lip 11a and dust lip 11b are inclined radially outward and adapted to slidingly contact the inner-side surface of the base portion 6b of the wheel mounting flange 6. The grease lip 11c is inclined toward the inboard-side of the bearing. Examples of materials used for the sealing member 11 other than NBR are e.g. HNBR (hydrogenated acrylonitrile-butadiene rubber), EPDM (ethylene propylene rubber) etc. having high heat resistance as well as ACM (polyacrylic rubber), FKM (fluorinated rubber) or silicone rubber having high heat resistance and chemical resistance.

Grease 12, with at least the same or thickener viscosity as that previously sealed in the bearing, is applied to each sliding-contact portion of the sealing lips. This reduces frictional torque of the lips. Accordingly, this reduces rotational torque of the seal 8 while keeping the bearing performance.

As shown in the enlarged view of FIG. 3, an inboard-side seal 9 is formed as a so-called pack seal. The seal 9 includes an annular sealing plate 13 and a slinger 14. Both have a substantially L-shaped cross-section and are arranged opposite to each other.

The annular sealing plate 13 includes a metal core 15 and sealing member 16. The metal core 15 is press-fit into the inboard-side end of the outer member 2. The sealing member 16 is integrally adhered to the metal core 15, via vulcanized adhesion. The metal core 15 is press-formed of ferritic stainless steel sheet, austenitic stainless steel sheet or preserved cold-rolled steel sheet. The metal core 15 has a substantially L-shaped cross-section with a cylindrical fitting portion 15a and a radial portion 15b. The cylindrical fitting portion 15a is press-fit into the end of the outer member 2. The radial portion 15b radially extends from the end of the fitting portion 15a. A tip end of the fitting portion 15a of the metal core 15 is thinned. The sealing member 16 covers the tip end of the fitting portion to form the half metal structure.

The slinger 14 is press-formed of ferritic stainless steel sheet, austenitic stainless steel sheet or preserved cold-rolled steel sheet. The slinger 14 has a substantially L-shaped cross-section with cylindrical portion 14a and an annular standing plate portion 14b. The cylindrical portion 14a is press-fit onto the outer circumference of the inner ring 5. The annular standing plate portion 14b extends radially outward from the cylindrical portion 14a. A small radial clearance is formed between the outer peripheral edge of the standing plate portion 14b and sealing member 16 to form a labyrinth seal 17.

The sealing member 16 is formed of synthetic rubber such as NBR etc. and includes a side lip 16a, a dust lip 16b and grease lip 16c. The side lip 16a slideably contacts the outboard-side surface of the standing plate portion 14b of the slinger 14, via a predetermined axial interference. The grease lip 16c and a dust lip 16b are formed as two branches formed radially inside of the side lip 16a. The dust lip 16b and grease lip 16c slidably contact the outer circumference of the cylindrical portion 14a of the slinger 14, via a predetermined radial interference. A magnetic encoder 18 is integrally adhered to the inboard-side surface of the standing plate portion 14b, via vulcanized adhesion. The magnetic encoder 18 is formed from elastomer mingled with magnetic powder such as ferrite and magnetized with magnetic poles N and S. The poles are alternately arranged along the circumferential direction of the encoder 18 to form a rotary encoder to detect rotational speed of a wheel.

Although the wheel bearing apparatus is shown here as a double row angular contact ball bearing using balls as the rolling elements 3, it should be noted that the present disclosure is not limited to such a wheel bearing apparatus. It can be applied to a double row tapered roller bearing using tapered rollers as the rolling elements. In addition, although shown as a third generation type wheel bearing apparatus with the inner raceway surface 4a directly formed on the outer circumference of the wheel hub 4, the present disclosure can be applied to wheel bearing apparatus of the second generation type where a pair of inner rings are press-fit onto a cylindrical portion of the wheel hub.

The method for controlling bearing clearance of the wheel bearing apparatus of the present disclosure will be described. First, the inner ring 5 is press-fit onto the cylindrical portion 4b of the wheel hub 4. It is stopped once just before a smaller end face 19 abuts against a shoulder portion 20 of the wheel hub 4 during the assembling stage of the wheel bearing apparatus, as shown in FIG. 4. That is, a predetermined distance S remains at this time between the smaller end face 19 of the inner ring 5 and the shoulder portion 20 of the wheel hub 4. Thus, the axial clearance of the bearing is positive. Under this state, placing the wheel bearing apparatus vertically, an axial distance (assembly width) T0 is measured from a reference surface (larger end face) 21 of the inner ring 5 to a reference surface (outboard-side surface of the wheel mounting flange 6) 22 of the wheel hub 4. Furthermore, the bearing initial axial clearance δ0 is measured from an axial moving amount of the outer member 2 relative to the inner member 1. In this case, the reference surface of the wheel hub 4 is not limited to the outboard-side surface 22 of the wheel mounting flange 6. It may be possible to use the outboard-side end face 23 as the reference surface of the wheel hub 4 and measure an axial distance T0′ from the reference surface (larger end face) 21 to the reference surface 23 of the wheel hub 4.

The inner ring 5 is continuously press-fit onto the wheel hub 4 until the smaller end face 19 of the inner ring 5 abuts against the shoulder portion 20 of the wheel hub 4, as shown in FIG. 5. An axial distance T1 is measured from the reference surface 21 of the inner ring 5 to the reference surface 22 of the wheel hub 4. An axial bearing clearance δ1 after the press-fitting of the inner ring 5 onto the wheel hub 4 is obtained from a formula δ1=δ0−(T0−T1).

Prior to the caulking process mentioned above, an operation process is performed to correct a caulking portion completion end position of the caulking apparatus 24. As shown in FIG. 6, the caulking apparatus 24 can arbitrarily change the completion end position of the caulking operation by moving a movable stopper 25. More particularly, a caulking jig 27 secured on a caulking head 26 abuts against a workpiece (i.e. wheel bearing apparatus) W vertically placed on a receptacle table B by descending the caulking head 26 by a predetermined stroke L. An assembly width T2 of a product (wheel bearing apparatus) after the caulking operation is changed by changing the completion end position of the caulking apparatus 24, as shown in FIG. 7. That is, an amount of variation of the bearing clearance (axial clearance) due to the caulking operation is changed. At this time, the bearing clearance (preload amount) δ2 of the finally assembled product after caulking can be obtained from a formula δ2=δ1+(T1−T2).

At this time, T2 is obtained by operating previously measured δ1 and T1 of individual products while keeping the bearing clearance δ2 of the finally assembled product constant. In other words, the caulking process is performed by adjusting the completion end position of the caulking apparatus 24 through the stopper 25. Thus, T2 is obtained by operating δ1 and T1 of the individual products. That is, the axial distance T2 after the caulking operation, between the reference surfaces of the wheel hub 4 and the inner ring 5. is obtained from a formula T2=δ2−δ1−T1. Thus, the axial distance T2 becomes a target value of the bearing clearance δ2 after the caulking operation. Accordingly, a completion end position of the caulking operation of a caulking apparatus 24 is changed. This makes it possible to keep the bearing clearance of the finally assembled products constant.

Furthermore, since the steps for measuring δ1 and T1 (i.e. step for press-fitting the inner ring 5 onto the wheel hub 4) and the caulking step are far apart from each other in the actual assembling process, it is substantially difficult to feedback the measured values of δ1 and T1 of individual products to the caulking step. Thus, according to the present embodiment, identification codes 28 such as QR codes (registered trade mark) etc. are printed on individual products (wheel bearing apparatus) as shown in FIG. 8. Thus, measured values of δ1 and T1 together with these identification codes 28 are stored in memories or magnetic memory devices. The identification codes 28 are read out to retrieve the information from the memories and feed back to the caulking process just before the caulking operation. The measured values of δ1 and T1 may be also incorporated into the identification codes 28 or printed together with the identification codes 28. This enables intermediate recorded data to remain on the products and thus a user may refer to the data without the need to refer to a memory means of a manufacturing factory.

Accordingly, it is possible to exactly set a desirable bearing clearance and also to exactly and stably control the preload amount of bearing. This occurs even if variations in materials or dimensions of the wheel hub 4 exist. The caulking process is adjusted so that the assembly width (T1−T2) becomes small when the bearing clearance before the caulking process is large and adversely, by adjusting the caulking process so that the assembly width (T1−T2) becomes large when the bearing clearance before caulking process is small. In addition, it is possible to surely prevent the occurrence of defective products inconvenience in performances such as under-caulking or over-caulking and to reduce manufacturing cost.

In such a case, it is supposed that the inner ring 5 would be deformed not only in an axial direction but in a radial direction. This gives influence to the bearing clearance when the inner ring 5 is axially secured by the caulked portion 4d. According to the present embodiment, a deformation amount of the inner ring 5 due to the caulking operation is previously measured. A corrected value γ of the deformation amount converted to the axial direction is added to a measured value δ2 of the bearing clearance after the caulking operation. This performs further exact bearing clearance control.

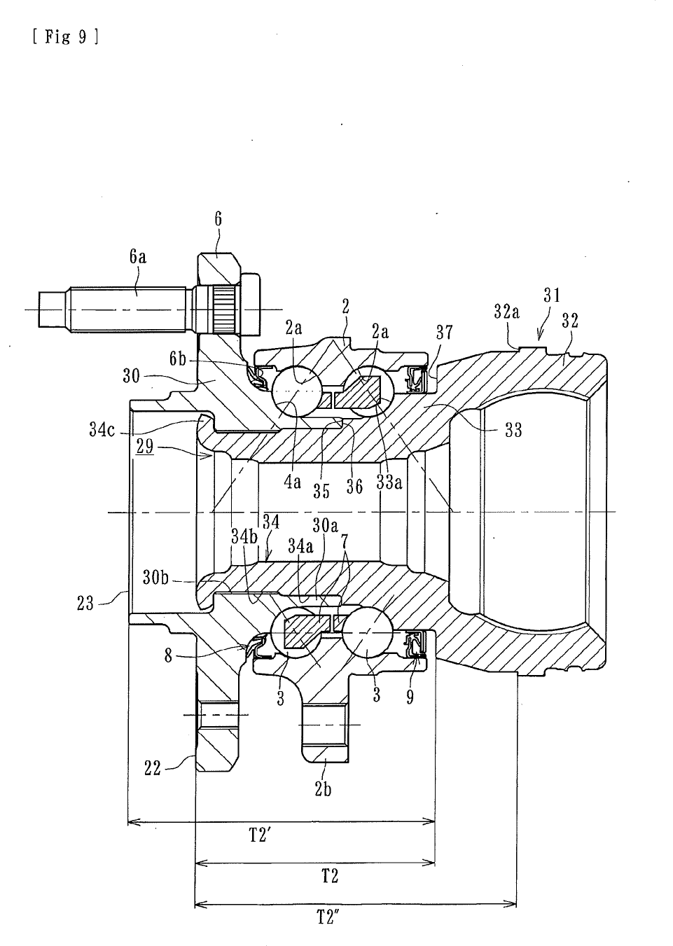

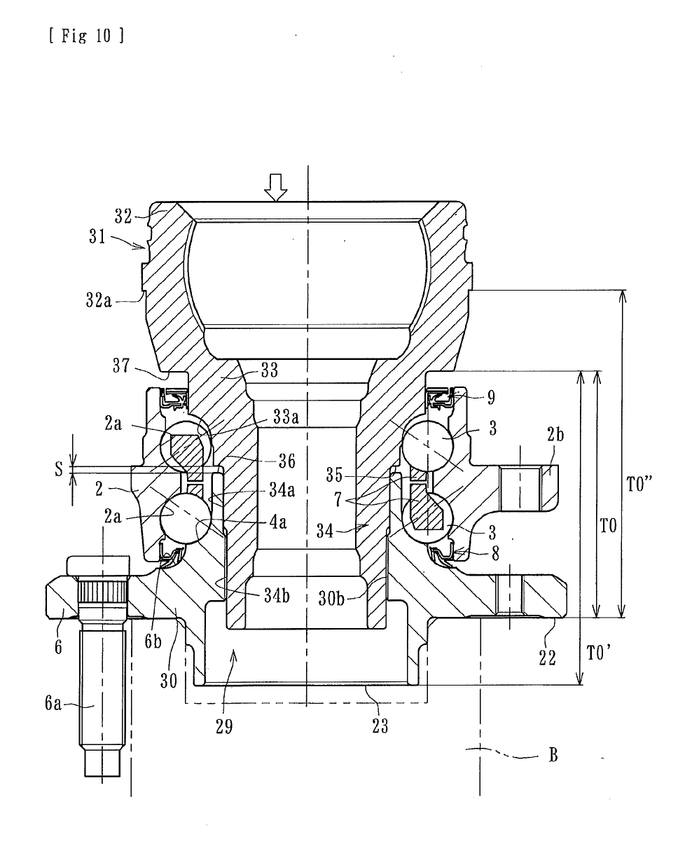

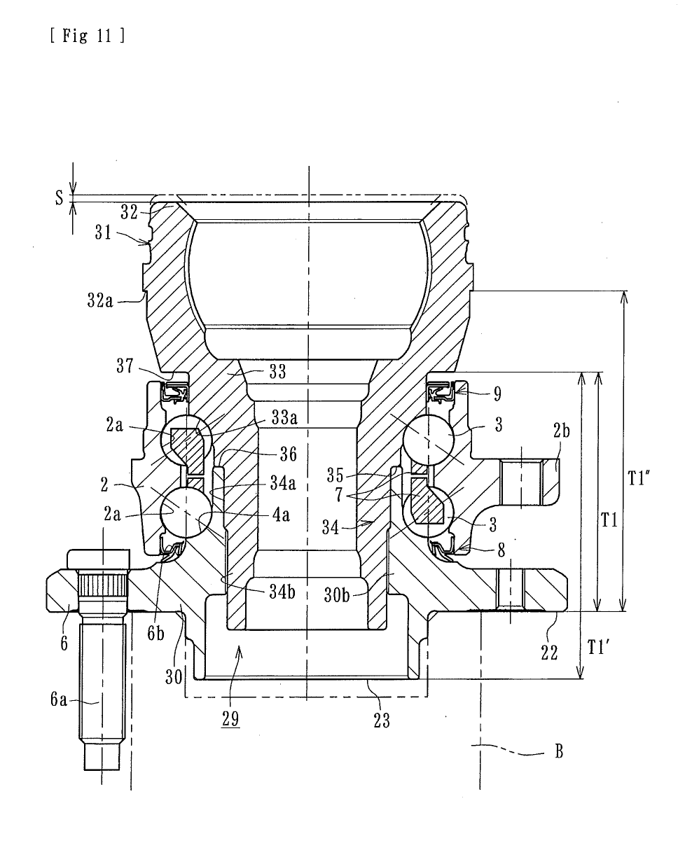

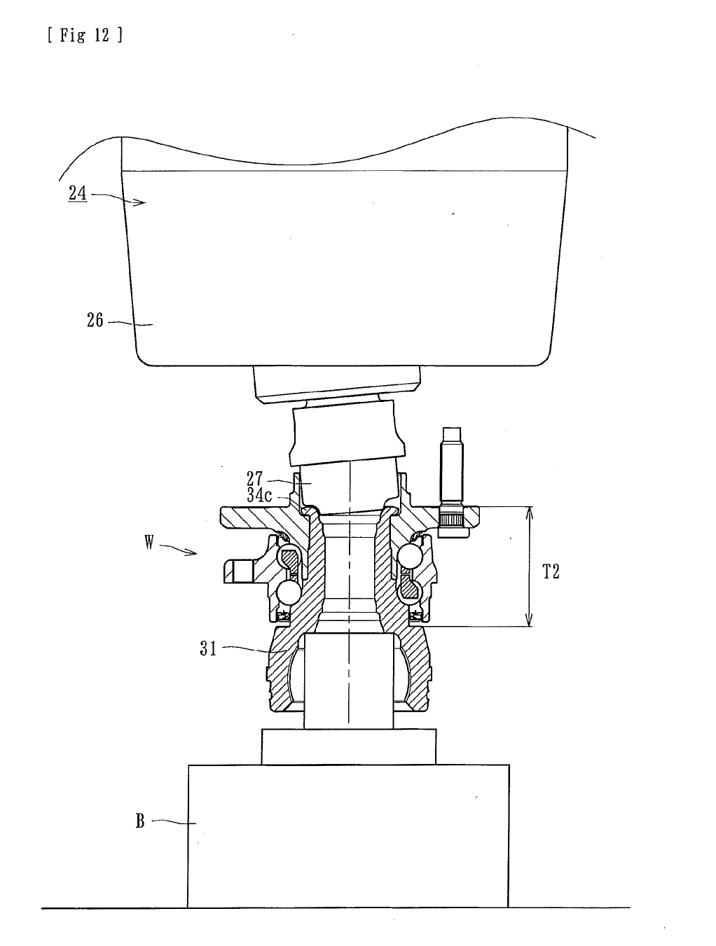

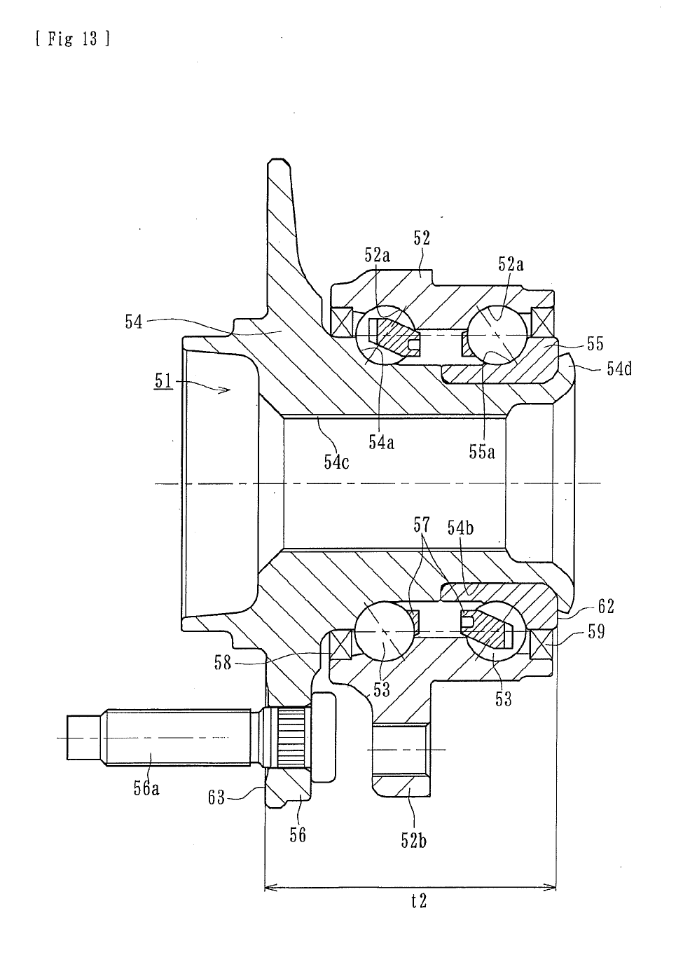

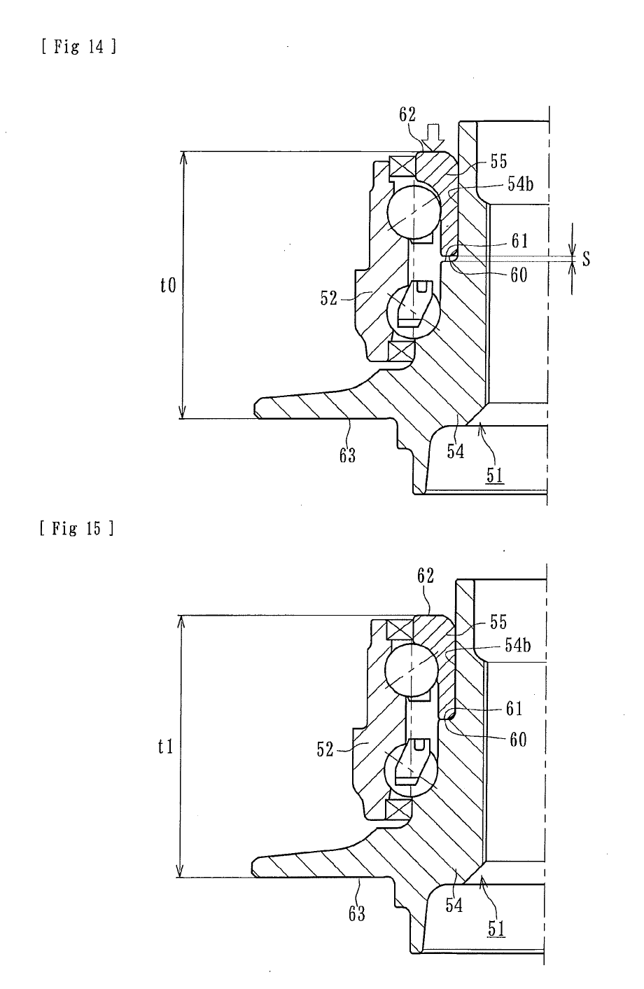

The second embodiment will be described with respect to a method for controlling bearing clearance of a wheel bearing apparatus of the fourth generation shown in FIG. 9. FIG. 9 is a longitudinal section view of a second preferable embodiment of the wheel bearing apparatus. FIG. 10 is an explanatory section view of a press-fitting process of an outer joint member of FIG. 9. FIG. 11 is an explanatory section view of a state after the press-fitting process of the outer joint member of FIG. 9. FIG. 12 is an explanatory view shown partially in section of a caulking process by the caulking apparatus of FIG. 6. The same reference numerals are used in this embodiment to identify structural elements that are the same in the first embodiment and repeating the description of them will be omitted.

The wheel bearing apparatus shown in FIG. 9 includes an inner member 29, an outer member 2, and double row rolling elements 3, 3 rollably contained between the inner and outer members 29, 2. The inner member 29 includes a wheel hub 30 and an outer joint member 31 of a constant velocity universal joint integrally joined to the wheel hub 30.

The wheel hub 30 is made of medium/high carbon steel including carbon of 0.40 to 0.80% by weight such as S53C. It has a wheel mounting flange 6 on its outboard-side end. An inner raceway surface 4a is formed on the wheel hub outer circumference. A cylindrical portion 30a axially extends from the inner raceway surface 4a. Serrations (or splines) 30b are formed on the wheel hub inner circumference. The wheel hub 30 is hardened by high frequency induction quenching so that a region from a base 6b of the wheel mounting flange 6, forming a seal land portion of the outboard-side seal 8, to the cylindrical portion 30a, including the inner raceway surface 4a, is hardened to have a surface hardness of HRC 58 to 64.

The constant velocity universal joint includes the outer joint member 31, a joint inner ring, cage and torque transmitting balls (not shown). The outer joint member 31 has a cup-shaped mouth portion 32. A shoulder portion 33 forms a bottom of the mouth portion 32. An inboard-side seal 9 is mounted on the shoulder portion 33. A cylindrical shaft portion 34 axially extends from the shoulder portion 33. The outer joint member 31 is integrally formed. The shoulder portion 33 outer circumference includes an inboard-side inner raceway surface 33a opposing one of the outer raceway surfaces 2a, 2a. The shaft portion 34 outer circumference includes spigot portion 34a fitting into the cylindrical portion 30a of the wheel hub 30, via a predetermined interference. Serrations (or splines) 34b mate with the serrations 30b of the wheel hub 30.

The outer joint member 31 is made of medium/high carbon steel including carbon of 0.40 to 0.80% by weight such as S53C. It is hardened by high frequency induction quenching so that a region from the shoulder portion 33 to the shaft portion 34, including the inner raceway surface 33a, is hardened to have a surface hardness of HRC 58 to 64. The end portion of the shaft portion 34 is not quenched and remains as is with its surface hardness after forging less than HRC 25.

The shaft portion 34 of the outer joint member 31 is fit into the wheel hub 30 until a stepped portion (shoulder) 35, between the shoulder portion 33 and the shaft portion 34 of the outer joint member 31, abuts against the end face of the cylindrical portion 30a of the wheel hub 30. In addition, the outer joint member 31 is integrally joined to the wheel hub 30 by caulked portion 34c. The caulked portion 34c is formed by plastically deforming the end of the shaft portion 34 radially outward.

The axial clearance δ1 of the bearing is measured in accordance with the previously mentioned method before the outer joint member 31 is caulked onto the wheel hub 30. That is, the outer joint member 31 is press-fit into the cylindrical portion 30a of the wheel hub 30 and stopped once just before the stepped portion 35 abuts against the end face 36 of the cylindrical portion 30a of the wheel hub 30 as shown in FIG. 10. A predetermined distance S remains at this time between the stepped portion 35 of the outer joint member 31 and the end face 36 of the cylindrical portion 30a of the wheel hub 30. Thus, the axial clearance of the bearing is positive. Under this state, the axial distance T0 is measured from a reference surface (side surface of the shoulder 33) 37 of the outer joint member 31 to the reference surface 22 of the wheel hub 30. Furthermore, the bearing initial axial clearance δ0 is measured from an axial moving amount of the outer member 2 relative to the inner member 29.

In this case, the reference surface of the wheel hub 30 is not limited to the outboard-side surface 22 of the wheel mounting flange 6. It may be possible to use the outboard-side end face 23 of the wheel hub 30 as the reference surface of the wheel hub 30 to measure an axial distance T0′. It may also be possible to measure an axial distance T0″ from the reference surface (stepped portion of the mouth portion 32) 32a of the outer joint member 31 to the reference surface 22 of the wheel hub 30.

Then, the outer joint member 31 is continuously press-fit into the wheel hub 30 until the stepped portion 35 of the outer joint member 31 abuts against the end face 36 of the cylindrical portion 30a of the wheel hub 30, as shown in FIG. 11. The axial distance T1 is measured from the reference surface 37 of the outer joint member 31 to the reference surface 22 of the wheel hub 30. An axial bearing clearance δ1 after the press-fitting of the outer joint member 31 into the wheel hub 30 is obtained from the formula δ1=δ0−(T0−T1).

Then as shown in FIG. 12, the caulked portion 34c is formed by plastically deforming (i.e. caulking) the end of the shaft portion 34 of the outer joint member 31 radially outward. This applies a preload to the bearing by pressing the wheel mounting flange 6 of the wheel hub 30 under a state where the outer joint member 31 is placed on the receptacle table B to support the preload and pressing force. That is, similarly to the first embodiment, the caulking jig 27 secured on the caulking head 26 abuts against a workpiece (i.e. wheel bearing apparatus) W by descending the caulking head 26 by a predetermined stroke.

The operation process for correcting a completion end position of the caulking operation of the caulking apparatus 24 is performed prior to the caulking process, mentioned above. This information is transferred to the caulking apparatus 24. An assembly width T2 of a product (wheel bearing apparatus) after the caulking operation is changed by setting a predetermined stroke with the stopper and changing the completion end position of the caulking apparatus 24. Thus, the amount of variation of the bearing clearance due to the caulking operation is changed. At this time, the bearing clearance (preload amount) δ2 of the finally assembled product after caulking can be obtained from the formula δ2=δ1+(T1−T2).

Also in this embodiment, T2 can be obtained by operating previously measured δ1 and T1 of individual products while keeping the bearing clearance δ2 of the finally assembled product constant. In other words, the caulking process is performed by adjusting the completion end position of the caulking apparatus 24 through the stopper 25 so that T2 is obtained by operating δ1, T1 of individual products.

The axial distances T1′, T2′ may be measured by using outboard-side end surface 23 of the wheel hub 30 as the reference surface for measuring not only the assembly width T0 but T1 and T2. Furthermore, it may be possible to measure axial distances T1″, T2″ from the reference surface 32a (stepped portion of the mouth portion 32) of the outer joint member 31 to the reference surface 22 of the wheel hub 30.

The present disclosure can be applied to wheel bearing apparatus of the self-retaining structure type where a wheel hub or an outer joint member of constant velocity universal joint, forming the bearing portion, is united by plastically deforming parts.

The present disclosure has been described with reference to the preferred embodiments and its modifications. Obviously, modifications and alternations will occur to those of ordinary skill in the art upon reading and understanding the preceding detailed description. It is intended that the present disclosure be construed as including all such alternations and modifications insofar as they come within the scope of the appended claims or the equivalents thereof.

What is claimed is:

1. A method for controlling bearing clearance of wheel bearing apparatus, the wheel bearing apparatus comprising:
an outer member, inner member and double row rolling elements, the outer member outer circumference includes a body mounting flange to be mounted on a body of a vehicle, the outer member inner circumference includes double row outer raceway surfaces; the inner member includes a wheel hub and an inner ring or an outer joint member of a constant velocity universal joint, the wheel hub formed on its one end with a wheel mounting flange, a cylindrical portion axially extends from the wheel mounting flange, the inner ring or the outer joint member is press-fit onto or into the cylindrical portion of the wheel hub, the inner member outer circumference includes double row inner raceway surfaces that oppose the double row outer raceway surfaces, the double row rolling elements are freely rollably contained between the outer raceway surfaces of the outer member and the inner raceway surfaces of the inner member, the inner ring or the outer joint member is secured on the wheel hub by a caulked portion, the caulked portion is formed by plastically deforming the end of the cylindrical portion of the wheel hub or the end of the outer joint member radially outward, the method comprises steps of:
measuring an axial distance (T0) and an initial axial clearance (δ0) between reference surfaces of the wheel hub and the inner ring or reference surfaces of the wheel hub and the outer joint member;
temporally stopping a press-fitting operation under a positive bearing clearance state during press-fitting of the inner ring or the outer joint member onto or into the cylindrical portion of the wheel hub;
measuring an axial distance (T1) between the reference surfaces of the wheel hub and the inner ring or the reference surfaces of the wheel hub and the outer joint member;
further continuing and completing the press-fitting operation;
obtaining an axial clearance (δ1) under this state from a formula δ1=δ0−(T0−T1);
obtaining an axial distance (T2) after the caulking operation between the reference surfaces of the wheel hub and the inner ring or the reference surfaces of the wheel hub and the outer joint member from a formula T2=δ2−δ1−T1 so that the axial distance (T2) becomes a target value of the bearing clearance (δ2) after the caulking operation; and
changing a completion end position of a caulking apparatus.

2. The method for controlling bearing clearance of wheel bearing apparatus of claim 1 further comprising a step of arbitrarily changing the completion end position of the caulking operation of the caulking apparatus by a movable stopper.

3. The method for controlling bearing clearance of wheel bearing apparatus of claim 1 further comprising steps of previously measuring a deformation amount of the inner ring due to the caulking operation and adding a corrected value (γ) of the deformation amount converted to the axial direction to the bearing clearance after the caulking operation.

4. The method for controlling bearing clearance of wheel bearing apparatus of claim 1, further comprising steps of transferring and storing the bearing clearance (δ1) and the axial distance (T1) before the caulking operation to the caulking apparatus together with identification codes printed on individual wheel bearing apparatus and retrieving the information just before the caulking operation by matching the identification codes to the information.

5. The method for controlling bearing clearance of wheel bearing apparatus of claim 1, wherein the inner member comprises the wheel hub and the outer joint member, the outer joint member is integrally formed with a cup-shaped mouth portion, a shoulder portion forms a bottom of the mouth portion, and a cylindrical shaft portion axially extending from the shoulder portion, the shaft portion is formed with a spigot portion fit into the cylindrical portion of the wheel hub via a predetermined interference and with a serration at one end of the spigot portion, the serration of the outer joint member engaging a serration formed on the inner circumference of the wheel hub, a preload is applied to the wheel bearing apparatus by pressing the wheel hub with the outer joint member while vertically placed on a receptacle table and the end of the shaft portion of the outer joint member is plastically deformed radially outward.
